(19) United States
(12) Patent Application Publication
(10) Pub. No.: US 2015/0230061 A1
(43) Pub. Date: Aug. 13, 2015

(54) DISTRIBUTED OPTIMIZATION FOR EVENT TRAFFIC CONTROL

(71) Applicant: VERIZON PATENT AND LICENSING INC., BASKING RIDGE, NJ (US)

(72) Inventor: Ashok N. SRIVASTAVA, MOUNTAIN VIEW, CA (US)

(73) Assignee: VERIZON PATENT AND LICENSING INC., BASKING RIDGE, NJ (US)

(21) Appl. No.: 14/176,600

(22) Filed: Feb. 10, 2014

(51) Int. Cl. H04W 4/04; G06Q 50/26; H04W 64/00; H04L 29/08

(52) U.S. Cl. CPC H04W 4/043; H04L 67/12; H04L 67/22; G06Q 50/265; H04W 64/00

(57) ABSTRACT

A user device provides, to a server device, event application setup information associated with the user device. The event application setup information includes information provided to the user device during configuration of an event application. The user device provides, to the server device, user device information associated with the user device. The user device information includes information identifying a current location of the user device, and is provided to the server device during an event that affects the user device. The user device receives, from the server device, custom event instructions based on the event application setup information, the user device information, and the event. The custom event instructions include information describing a recommended route, away from a location of the event, that is customized for the user device. The user displays the custom event instructions.

### BACKGROUND

A physical area, such as a city, a town, a building, etc., may require occupants to evacuate the physical area due to an event, such as a hurricane, a blizzard, a wildfire, a biological attack, a terrorist attack, etc. Many times the occupants are instructed to follow the same fixed evacuation routes for all of the different types of events. As such, there are typically signs marking predetermined roadways as “evacuation routes.” Some events, such as a wildfire and a terrorist attack, are more dynamic in nature, and the optimal evacuation plan cannot be predicted due to uncertainties in how the event will unfold.

Such occupants (or users) may utilize user devices to communicate with one another and/or to communicate with emergency operations systems (e.g., provided by weather agencies, government agencies, the police, the fire department, etc.). A user device may include a mobile computation and communication device, such as a radiotelephone, a personal communications system (PCS) terminal, a personal digital assistant (PDA), a smart phone, a laptop computer, a tablet computer, etc.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of a device that may correspond to one or more of the devices of the environment depicted in FIG. 2;

FIG. 4 is a flow chart of an example process for receiving and configuring an event application for a user device;

FIGS. 5A and 5B are diagrams of example user interfaces that may be used in connection with the example process shown in FIG. 4;

FIG. 6 is a flow chart of an example process for determining custom event instructions for user devices during an occurrence of an event;

FIGS. 7A-7D are diagrams of an example relating to the example process shown in FIG. 6;

FIG. 8 is a flow chart of another example process for displaying and updating custom event instructions received during an occurrence of an event; and

FIGS. 9A-9F are diagrams of an example relating to the example process shown in FIG. 8.

### DETAILED DESCRIPTION OF PREFERRED EMBODIMENTS

The following detailed description refers to the accompanying drawings. The same reference numbers in different drawings may identify the same or similar elements.

Current emergency operations systems do not have access to tools necessary to dynamically identify optimal routes for evacuation during an event. Such systems are incapable of making dynamic determinations of what route may be best at any particular time or for any particular event. For example, assume that an event, such as a bomb threat, occurs in a city that requires occupants of the city to evacuate. Further assume that there are only twenty (20) possible exits from the city, and that the occupants need to evacuate the city within thirty (30) minutes. Unfortunately, current emergency operations systems do not include tools necessary to successfully coordinate evacuation of the city in such an example.

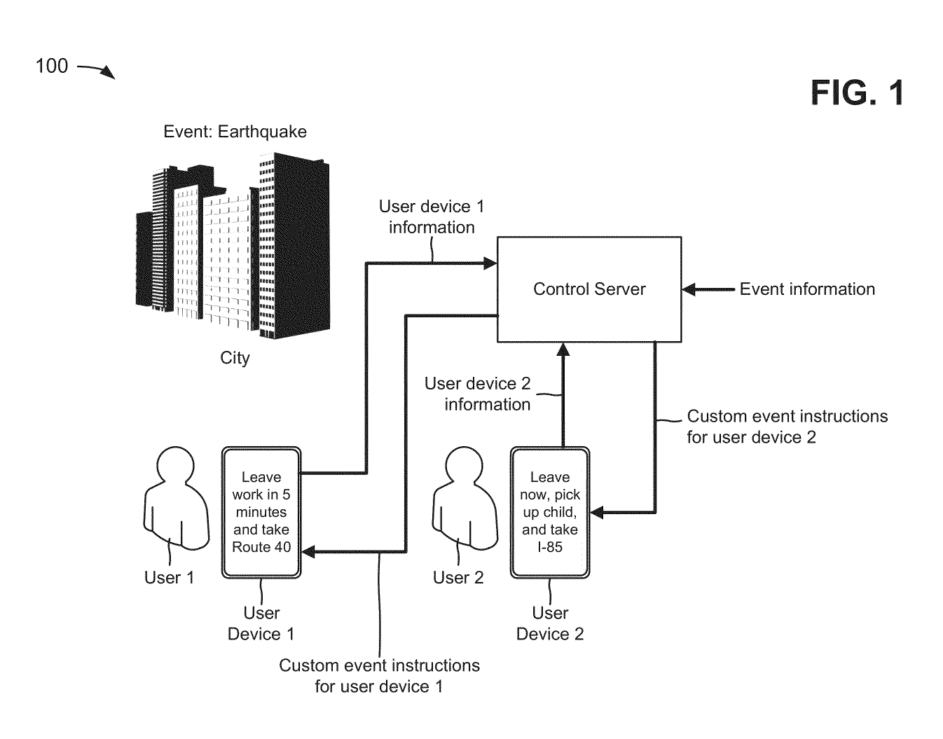

FIG. 1 is a diagram of an overview of an example implementation 100 described herein. In example implementation 100, assume that a first user device (e.g., User Device 1) and a second user device (e.g., User Device 2) are associated with a control server. Further, assume that the first user device is associated with a first user (e.g., User 1), and that the second user is associated with a second user (e.g., User 2). As shown in FIG. 1, the first user and the second user may be located in a physical area (e.g., a city), and the city may be experiencing or about to experience an event (e.g., an earthquake).

In example implementation 100, further assume that the first user previously downloaded (e.g., from the control server) and installed an event application on the first user device, and that the second user previously downloaded (e.g., from the control server) and installed the event application on the second user device. The event application may enable the first user and the second user to set preferences for receiving custom event instructions from the control server when an event occurs, such as the earthquake in the city. The preferences may include providing the event application with access to global positioning system (GPS) coordinates of the user devices, navigation applications of the user devices, etc.; user-specified routes to take during an event; notifications to send during an event; sharing location information and user actions during the event with other user devices; etc.

As further shown in FIG. 1, the first user device may provide first user device information to the control server, and the second user device may provide second user device information to the control server. The first user device information may include a current location, sensor information (e.g., sound from a microphone, video from a camera, vibration, etc.), call information, text message information, etc. associated with the first user device. The second user device information may include a current location, sensor information, call information, text message information, etc. associated with the second user device. As further shown in FIG. 1, the control server may receive event information from a trusted entity, such as a government agency, a weather service, law enforcement, etc. The event information may include identification of the event (e.g., the earthquake), a location affected by the event (e.g., the entire city), current inaccessible routes (e.g., streets, roads, highways, etc.) caused by the event, etc.

The control server may determine custom event instructions for the first user device based on the preferences set by the first user for the event application, the first user device information, and/or the event information. The control server may provide the custom event instructions to the first user device, and the first user device may display the custom event instructions to the first user. For example, the custom event instructions may instruct the first user to leave in five minutes and take Route 40 out of the city. The first user may follow the custom event instructions or may ignore the custom event instructions. If the first user ignores the custom event instructions, the event application may determine updated custom event instructions based on the first user's actions (e.g., waited longer to leave, stopped at an unexpected location, etc.).

The control server may determine custom event instructions for the second user device based on the preferences set by the second user for the event application, the second user device information, and/or the event information. The control server may provide the custom event instructions to the second user device, and the second user device may display the custom event instructions to the second user. For example, the custom event instructions may instruct the second user to leave now, pick up the second user's child, and take I-85 out of the city. The second user may follow the custom event instructions or may ignore the custom event instructions. If the second user ignores the custom event instructions, the event application may determine updated custom event instructions based on the second user's actions.

In some implementations, the custom event instructions may be provided to other user devices, and may provide instructions that maximize a number of users exiting the city in a minimum amount of time (e.g., by preventing traffic jams, warning of closed routes, etc.). In some implementations, the control server may determine the custom event instructions by using convex optimization techniques to solve a distributed control problem. The custom event instructions may maximize an exit rate of users from an area experiencing an event, based on real-time information about locations, trajectories, and other behavioral information about the users in the area. In some implementations, the event application of the user devices may utilize the convex optimization techniques to update the custom event instructions.

Systems and/or methods described herein may maximize a number of users exiting a physical area (e.g., a city) experiencing an event (e.g., an emergency) in a minimum amount of time. The systems and/or methods may dynamically determine what route may be best at any particular time, for any particular event, and for any particular user. The systems and/or methods may enable the user devices to determine or update routes provided by the control server to the user devices (e.g., via the custom event instructions). The systems and/or methods may provide decentralized control to the users of the user devices and may provide flexibility in determining routes during an event. The systems and/or methods may reduce a demand placed on a communication network and/or the control server by enabling the user devices to determine or update the routes.

An event, as used herein, is to be broadly interpreted to include an accident (e.g., a car accident, a train accident, a traffic jam, etc.); a natural disaster (e.g., an earthquake, a flood, a weather event, a fire etc.); a manmade disaster (e.g., a bridge collapse, a discharge of a hazardous material, an explosion, etc.); a security event (e.g., a terrorist attack, an act of war, a bomb threat, etc.); an event that may trigger a response from authorities and/or emergency personnel (e.g., police, firefighters, paramedics, a government agency, etc.); and/or an event that may trigger a notification to a large quantity (e.g., greater than some threshold) of user devices.

Although implementations will be described herein in relation to emergency-related events (e.g., accidents, natural disasters, manmade disasters, etc.), the systems and/or methods may be utilized to provide decentralized control and efficient routing of any type of traffic relating to humans (e.g., foot traffic at a sporting event, an election event, a concert, an airport, etc.) and/or networks (e.g., packets in a packet-based network, traffic associated with an access network, etc.).

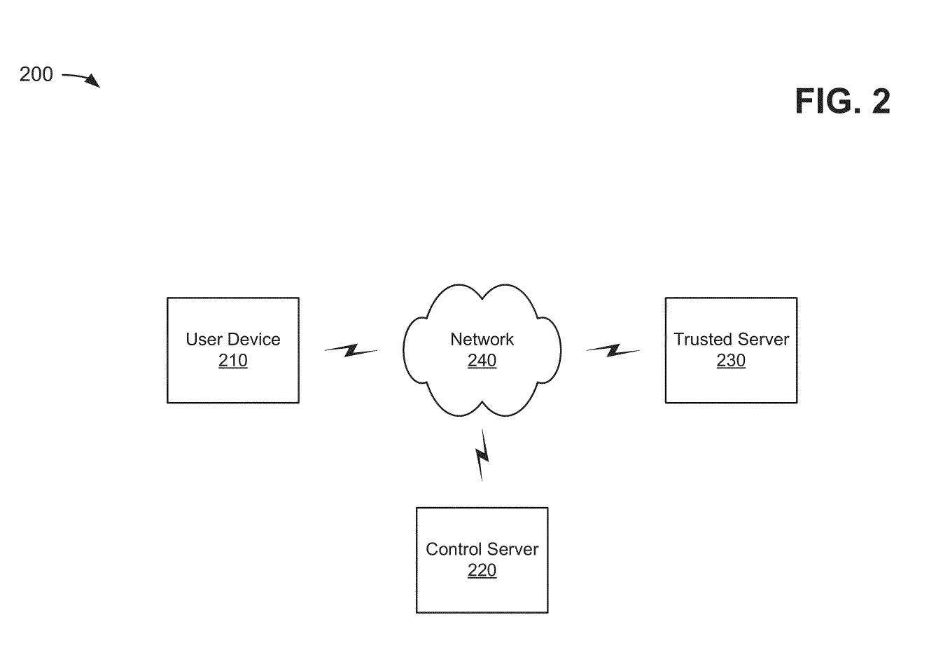

FIG. 2 is a diagram of an example environment 200 in which systems and/or methods described herein may be implemented. As illustrated, environment 200 may include a user device 210, a control server 220, a trusted server 230, and a network 240. Devices/networks of environment 200 may interconnect via wired connections, wireless connections, or a combination of wired and wireless connections.

User device 210 may include a device that is capable of communicating over network 240 with control server 220 and/or trusted server 230. In some implementations, user device 210 may include a radiotelephone; a personal communications services (PCS) terminal that may combine, for example, a cellular radiotelephone with data processing and data communications capabilities; a smart phone; a personal digital assistant (PDA) that can include a radiotelephone, a pager, Internet/intranet access, etc.; a laptop computer; a tablet computer; a GPS device; a gaming device; or another type of computation and communication device. In some implementations, user device 210 may include an event application that is downloaded from control server 220. The event application may enable a user of user device 210 to set preferences for receiving custom event instructions from control server 220 when an event occurs.

Control server 220 may include one or more personal computers, workstation computers, server devices, one or more virtual machines (VMs) provided in a cloud computing environment, or other types of computation and communication devices. In some implementations, control server 220 may provide the event application to user device 210 upon request. In some implementations, control server 220 may receive, from user device 210, information, such as, for example, a current location, sensor information, call information, text message information, etc. associated with user device 210. In some implementations, control server 220 may receive, from trusted server 230, event information, such as, for example, identification of the event, a location affected by the event, current inaccessible routes caused by the event, etc. In some implementations, control server 220 may determine custom event instructions for user device 210 based on the preferences set by the user for the event application, the information received from user device 210, and/or the event information.

Trusted server 230 may include one or more personal computers, workstation computers, server devices, or other types of computation and communication devices. In some implementations, trusted server 230 may be associated with a trusted entity, such as, for example, a government agency, a weather service, law enforcement, a fire department, etc. In some implementations, trusted server 230 may identify an event (e.g., an earthquake, a terrorist act or threat, a wildfire, a hurricane, a blizzard, etc.), and may generate event information for the event. In some implementations, trusted server 230 may provide the event information to control server 220 when the event is identified by trusted server 230.

Network 240 may include a network, such as a local area network (LAN), a wide area network (WAN), a metropolitan area network (MAN), a telephone network, such as the Public Switched Telephone Network (PSTN) or a cellular network, an intranet, the Internet, a fiber optic network, a satellite network, or a combination of networks.

The number of devices and/or networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

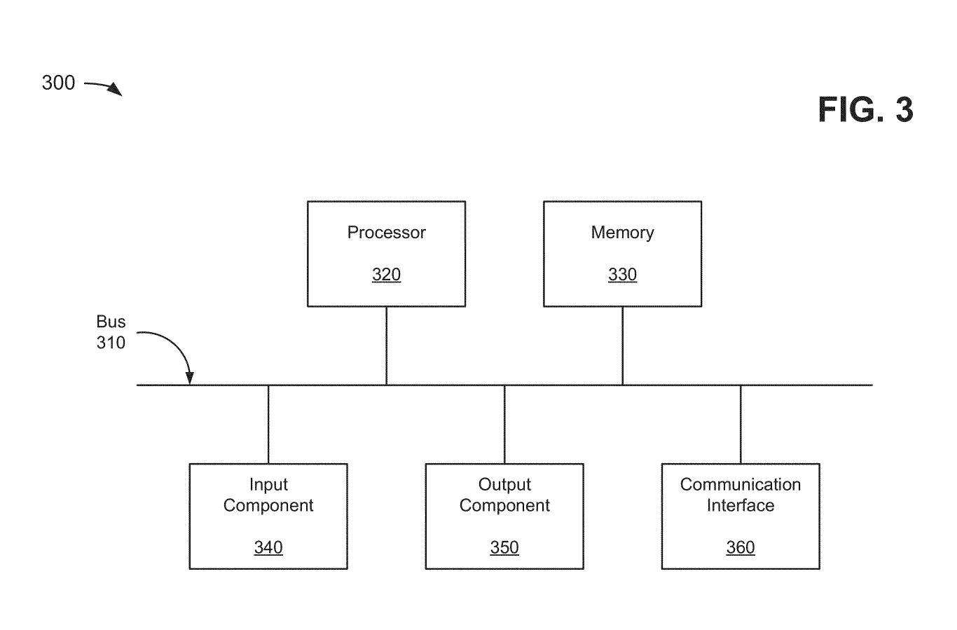

FIG. 3 is a diagram of example components of a device 300 that may correspond to one or more of the devices of environment 200. In some implementations, one or more of the devices of environment 200 may include one or more devices 300 or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit, etc.), a microprocessor, and/or any processing component (e.g., a field-programmable gate array (FPGA), an application-specific integrated circuit (ASIC), etc.) that interprets and/or executes instructions, and/or that is designed to implement a particular function. In some implementations, processor 320 may include multiple processor cores for parallel computing. Memory 330 may include a random access memory (RAM), a read only memory (ROM), and/or another type of dynamic or static storage component (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, etc.). Output component 350 may include a component that outputs information from device 300 (e.g., a display, a speaker, one or more light-emitting diodes (LEDs), etc.).

Communication interface 360 may include a transceiver-like component, such as a transceiver and/or a separate receiver and transmitter, which enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (RF) interface, a universal serial bus (USB) interface, a high-definition multimedia interface (HDMI), or the like.

Device 300 may perform various operations described herein. Device 300 may perform these operations in response to processor 320 executing software instructions included in a computer-readable medium, such as memory 330. A computer-readable medium is defined as a non-transitory memory device. A memory device includes memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided as an example. In practice, device 300 may include additional components, fewer components, different components, or differently arranged components than those shown in FIG. 3. Additionally, or alternatively, one or more components of device 300 may perform one or more functions described as being performed by another one or more components of device 300.

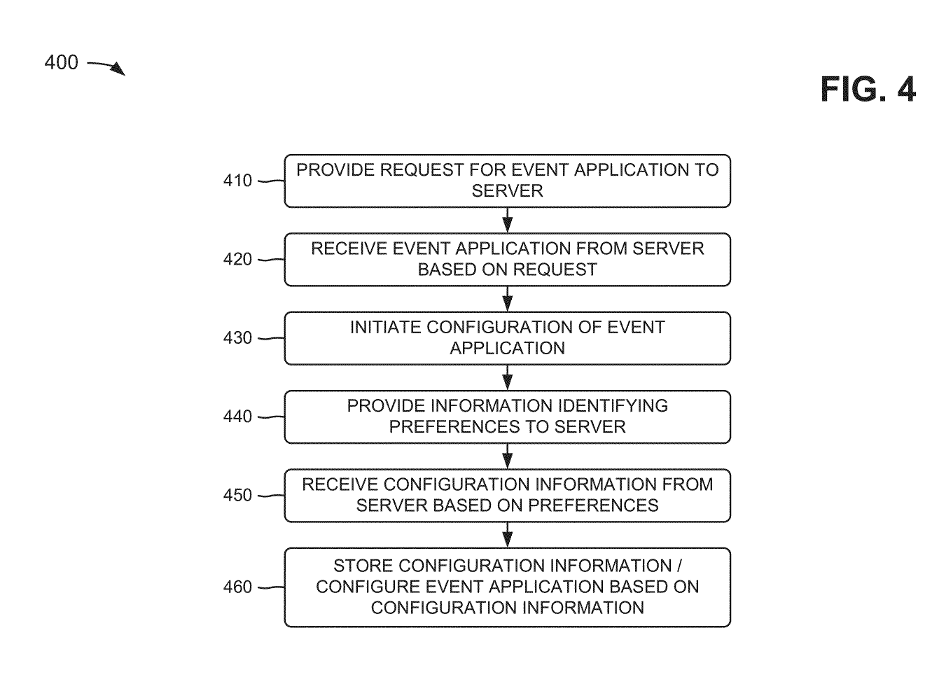

FIG. 4 is a flow chart of an example process 400 for receiving and configuring an event application for a user device. In some implementations, one or more process blocks of FIG. 4 may be performed by user device 210. In some implementations, one or more process blocks of FIG. 4 may be performed by another device or a group of devices separate from or including user device 210.

As shown in FIG. 4, process 400 may include providing a request for an event application to a server (block 410). For example, a user may cause user device 210 to provide a request for an event application to control server 220 and/or to an application store (e.g., accessed via a browser) hosted by one or more other server devices. In some implementations, the event application may include an application, a code snippet, a script, a widget, etc. that may cause user device 210 to perform one or more functions. For example, the event application may enable the user to set preferences for receiving custom event instructions from control server 220 when an event occurs near a location associated with the user and user device 210. In some implementations, the user may cause user device 210 to access the event application via, for example, a user interface (such as a browser) or in another manner. The user may then select, using user device 210, information regarding the event application from the user interface to cause user device 210 to provide a request for the event application to control server 220. In some implementations, control server 220 may offer the event application to user device 210 without user device 210 providing the request for the event application.

As further shown in FIG. 4, process 400 may include receiving the event application from the server based on the request (block 420). For example, user device 210 may receive the event application from control server 220 and/or the one or more other server devices, and may store the event application in a memory associated with user device 210 (e.g., memory 330, FIG. 3). In some implementations, the user, of user device 210, may establish an account associated with the event application prior to or after receiving the event application.

As further shown in FIG. 4, process 400 may include initiating a configuration of the event application (block 430). For example, the user may initiate the event application and identify, using user device 210, one or more preferences relating to receiving custom event instructions from control server 220 when an event occurs. In some implementations, the user may identify the one or more preferences using one or more elements of a user interface provided by user device 210. The one or more elements may include, for example, one or more text input elements, one or more drop down menu elements, one or more checkbox elements, one or more radio button elements, and/or any other types of elements that may be used to receive information from the user.

In some implementations, the one or more preferences may include a preference of the user with respect to providing the event application with access to functionality of user device 210, such as, for example, GPS coordinates of user device 210, a navigation application of user device 210, data usage by user device 210, etc.

In some implementations, the one or more preferences may include a preference of the user with respect to whether the user has a vehicle to use to exit an area during an event. In some implementations, the one or more preferences may include a preference of the user with respect to a preferred exit route to use during an event. For example, the user may indicate a preferred exit route (e.g., with directions, route names, etc.) to use during a daytime event, a preferred exit route to use during a nighttime event, way points in the preferred exit route (e.g., stopping to pick up children at school, a spouse at work, etc.), etc.

In some implementations, the one or more preferences may include a preference of the user with respect to the event application sending notifications associated with actions of the user during the event (e.g., leaving an area, traveling a certain route, a rendezvous point, etc.). For example, the user may indicate that the event application is to send notifications to social network friends via a social network, contacts stored on user device 210 (e.g., via text messaging, email, etc.), family members (e.g., via text messaging, email, etc.), etc.

In some implementations, the one or more preferences may include a preference of the user with respect to privacy settings for the event application. For example, the user may indicate that the user wishes to share actions of the user during the event (e.g., leaving an area, traveling a certain route, a rendezvous point, etc.) with all other users of the event application in the physical area of the event, with select users (e.g., family members, work colleagues, friends, social network friends, etc.), etc.

In some implementations, a type of the account, of the user, associated with the event application may determine the quantity of preferences that the user is able to specify. For example, the event application may enable the user to specify only a portion of the above preferences or specify additional preferences based on the type of the account with which the user is associated.

As further shown in FIG. 4, process 400 may include providing information identifying one or more preferences to the server (block 440). For example, the user may cause user device 210 to provide, to control server 220, information identifying the one or more preferences relating to the user and provided during the configuration of the event application.

As further shown in FIG. 4, process 400 may include receiving configuration information from the server based on the preferences (block 450). For example, user device 210 may receive, from control server 220, configuration information that may be used to configure the event application to cause user device 210 to provide information to control server 220 and to receive custom event instructions from control server 220 when an event occurs.

In some implementations, control server 220 may generate the configuration information, which may be used to configure the event application, based on the information identifying the one or more preferences of the user. For example, the configuration information may include information that causes user device 210 to provide the event application with access to functionality of user device 210, such as, GPS coordinates of user device 210, a navigation application of user device 210, data usage by user device 210, etc.

In some implementations, the configuration information may include information that causes user device 210 to determine and/or to inform control server 220 about whether the user has a vehicle, a preferred exit route to use during a daytime event, a preferred exit route to use during a nighttime event, way points in the preferred exit route, etc. In some implementations, the configuration information may include information that causes user device 210 to send notifications (e.g., to other users) associated with actions of the user during the event (e.g., leaving an area, traveling a certain route, a rendezvous point, etc.). In some implementations, the configuration information may include information that causes user device 210 to share actions of the user during the event with all other users of the event application in the physical area of the event, with select users, etc.

In some implementations, the configuration information may be obtained from a data structure. In some implementations, control server 220 may provide, to user device 210, the configuration information independent of receiving the information identifying the one or more preferences of the user.

As further shown in FIG. 4, process 400 may include storing the configuration information and configuring the event application based on the configuration information (block 460). For example, the user may cause user device 210 to store all or a portion of the configuration information received from control server 220. The event application may be configured based on storing all or a portion of the configuration information.

In some implementations, control server 220 may provide updates, to the configuration information, to user device 210 based on use of the event application by the user and/or by other users of user devices 210. For example, control server 220 may receive updates, to the configuration information, from one or more other users and may provide the received updates to user device 210. User device 210 may store the updates to the configuration information. In some implementations, control server 220 may provide the updates periodically based on a preference of the user and/or based on a time frequency determined by control server 220. In some implementations, control server 220 may determine whether to provide the updates based on the type of the account associated with the user.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

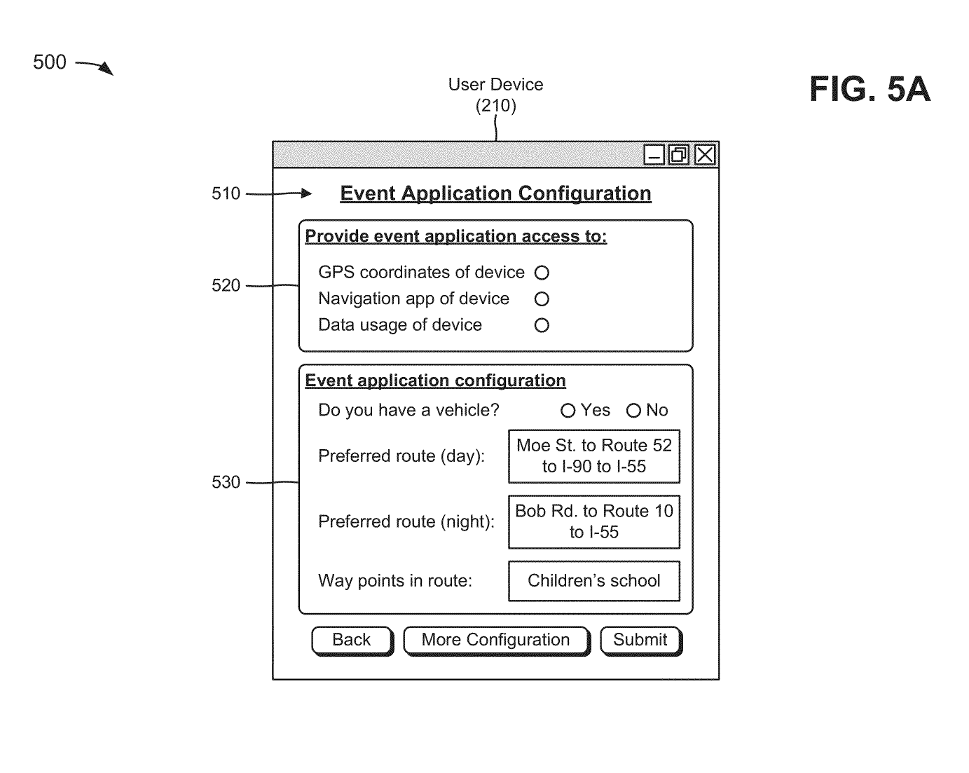

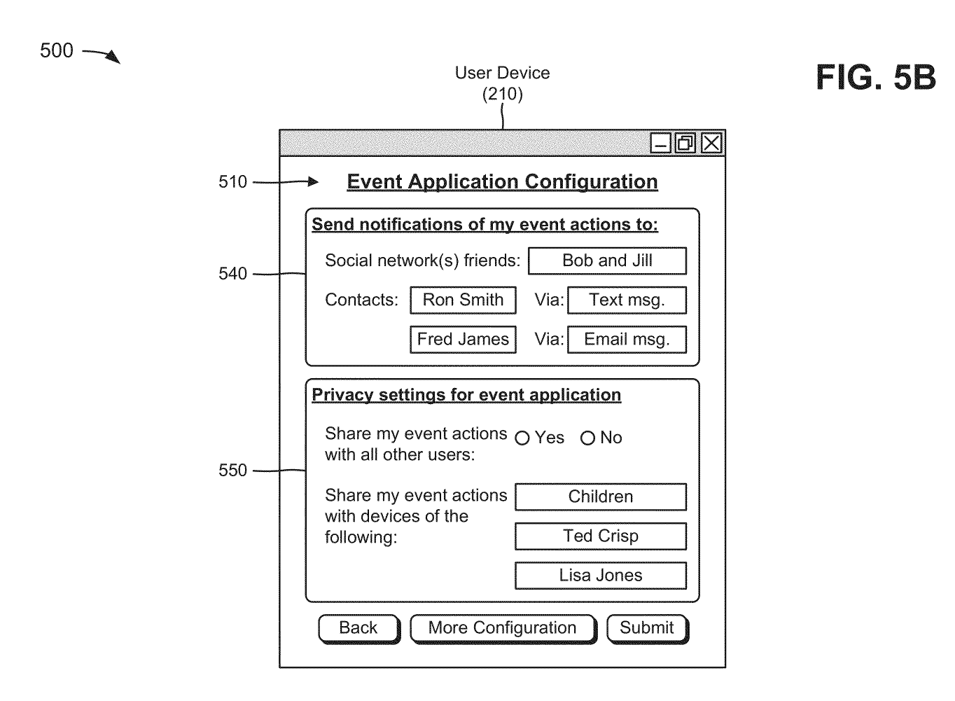

FIGS. 5A and 5B are diagrams 500 of example user interfaces that may be used in connection with example process 400 shown in FIG. 4. In some implementations, the user interfaces of FIGS. 5A and 5B may be provided by user device 210 to a user to enable the user to identify information (e.g., preferences) that may be used to configure the event application so that user device 210 provides information to control server 220 and receives custom event instructions from control server 220 when an event occurs.

Assume that the user has previously caused user device 210 to request and download the event application. Further assume that the user causes user device 210 to install the event application on user device 210. When user device 210 installs the event application, as shown in FIG. 5A, control server 220 may provide a user interface 510 to user device 210, and user device 210 may display user interface 510 to the user. User interface 510 may allow the user to configure different features of the event application. For example, the user may identify preferences for providing the event application with access to functionality of user device 210 in a first configuration section 520. In some implementations, the user may indicate that the user wants to provide the event application with access to GPS coordinates of user device 210. In some implementations, the user may indicate that the user wants to provide the event application with access to a navigation application of user device 210. In some implementations, the user may indicate that the user wants to provide the event application with access to data usage of user device 210. In some implementations, the user may indicate that the user wants to provide the event application with access to other functionality of user device 210.

As further shown in FIG. 5A, the user may identify preferences for configuring the event application in a second configuration section 530. In some implementations, the user may indicate whether the user has a vehicle to utilize during the occurrence of an event. In some implementations, the user may indicate a preferred exit route to utilize during a daytime event (e.g., “Moe St. to Route 52 to I-90 to I-55”). In some implementations, the user may indicate a preferred exit route to utilize during a nighttime event (e.g., “Bob Rd. to Route 10 to I-55”). In some implementations, the user may indicate way points in a preferred exit route (e.g., an address of “Children's school”).

As shown in FIG. 5B, the user may identify preferences for sending notifications about actions of the user during the event (e.g., leaving an area, traveling a certain route, a rendezvous point, etc.) in a third configuration section 540. In some implementations, the user may indicate whether the user wants to send a notification about the user's actions to one or more social network friends via one or more social networks (e.g., send a notification to “Bob and Jill”). In some implementations, the user may indicate whether the user wants to send a notification about the user's actions to one or more contacts stored on user device 210 and may indicate a notification method (e.g., send a notification to “Ron Smith” via text message and send a notification to “Fred James” via an email message). In some implementations, the user may indicate whether the user wants to send a notification about the user's actions to one or more other users.

As further shown in FIG. 5B, the user may identify preferences for privacy settings for the event application in a fourth configuration section 550. In some implementations, the user may indicate whether the user wants to share actions of the user during the event with all other users of the event application who are located in the physical area of the event. In some implementations, the user may indicate whether the user wants to share the user's actions with user devices 210 associated with particular users (e.g., “Children,” “Ted Crisp,” and “Lisa Jones”).

Once the user has identified the preferences, user interface 510 may allow the user to select a “Submit” option to store the preferences and/or submit the preferences to control server 220. Control server 220 may then provide, to user device 210, configuration information based on the preferences.

As further shown in FIGS. 5A and 5B, user interface 510 may also allow the user to select a “Back” option to cause user device 210 to provide information regarding the event application. As also shown in FIGS. 5A and 5B, user interface 510 may also allow the user to select a “More Configuration” option to enable the user to identify additional information that may be used to configure the event application.

The number of elements of user interface 510 shown in FIGS. 5A and 5B is provided for explanatory purposes. In practice, user interface 510 may include additional elements, fewer elements, different elements, or differently arranged elements than those shown in FIGS. 5A and 5B.

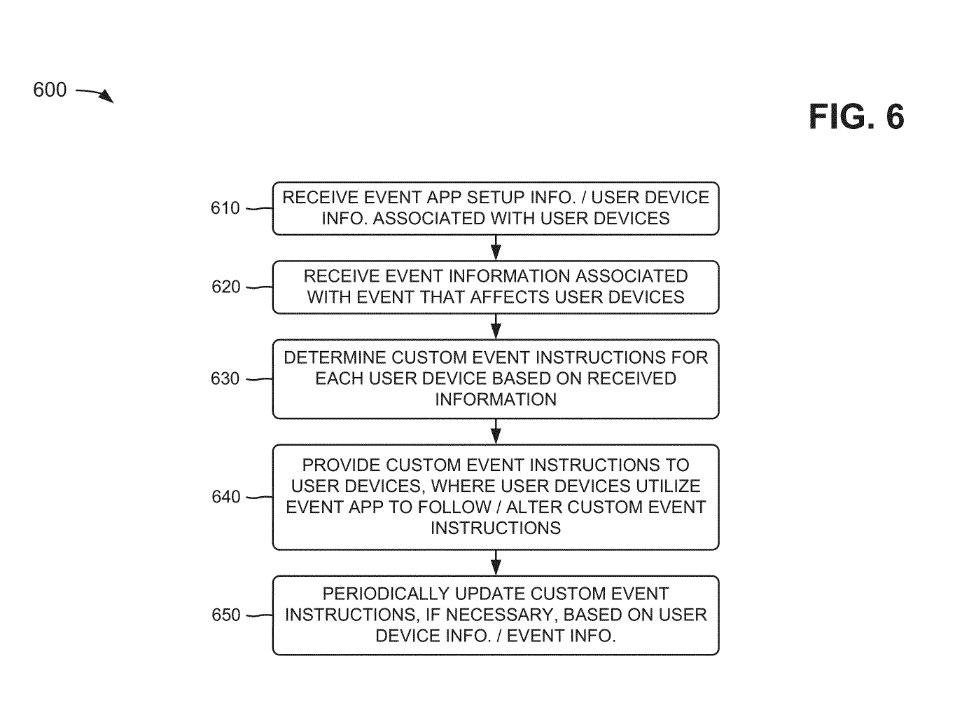

FIG. 6 is a flow chart of an example process 600 for determining custom event instructions for user devices during an occurrence of an event. In some implementations, one or more process blocks of FIG. 6 may be performed by control server 220. In some implementations, one or more process blocks of FIG. 6 may be performed by another device or a group of devices separate from or including control server 220.

As shown in FIG. 6, process 600 may include receiving event application setup information and user device information associated with user devices (block 610). For example, control server 220 may receive preferences provided by users of user devices 210 during configuration of the event application by the users, as described above in connection with FIGS. 4-5B. In some implementations, the preferences may be referred to as event application setup information, and may include, for example, providing the event application with access to GPS coordinates, navigation applications, data usage, etc. of user devices 210; user-specified routes to take during an event; types and methods of providing notifications to send during an event; sharing location information and user actions during the event with other user devices 210; types of user devices 210; etc.

In some implementations, control server 220 may receive user device information associated with user devices 210 that are physically located in an area affected by an event. The user device information may include, for example, current locations, sensor information (e.g., sound from a microphone, video from a camera, vibration, etc.), call information, text message information, etc. associated with user devices 210 at the time of the event. For example, if user device 210 is located in a building where a bomb is detonated, user device 210 may provide current GPS coordinates of user device 210 to control server 220. In some implementations, a particular user device 210 may not be physically located in the area affected by the event, but still may provide the user device information to control server 220. For example, the user of the particular user device 210 may establish a profile or an account, via the event application, with control server 220, and the profile may indicate that the user lives in the area affected by the event. However, the user of the particular user device 210 may be on vacation (e.g., and possess the particular user device 210) at a location that is different than the area affected by the event. In such an example, control server 220 may require the user to verify where the user is physically located.

In some implementations, user device 210 may enable sensors of user device 210, such as, for example, a microphone of user device 210 (e.g., to provide sounds encountered by user device 210 to control server 220); a camera of user device 210 (e.g., to provide video captured by user device 210 to control server 220); a motion sensor of user device 210 (e.g., to provide vibrations encountered by user device 210 to control server 220); etc. Such sensor information may enable control server 220 to assess current conditions associated with the area of the event. In some implementations, the call information of user device 210 may enable control server 220 to determine whether the user placed any emergency calls (e.g., “911” calls) associated with the event and whether the user is safe. In some implementations, the text information may enable control server 220 to determine whether the user is safe.

In some implementations, user device 210 may provide message content, video content, image content, audio/voice content, call content, browsing content and/or other network content to control server 220 so that an operation may be performed on the content. The operation on the content may include, for example, distributing streaming media associated with an event (e.g., video, audio, text, images, etc.); detecting particular content signatures associated with an event, such as key words, key faces (e.g., using facial recognition to identify a missing person, a fugitive, etc.), key sounds (e.g., using audio signatures to detect an explosion, a particular voice, a gunshot, etc.), key locations (e.g., using visual signatures to identify a location associated with an event, etc.); and/or other operations.

As further shown in FIG. 6, process 600 may include receiving event information associated with an event that affects the user devices (block 620). For example, control server 220 may receive, from trusted server 230, event information associated with an event located in a physical area that affects the users of user devices 210. In some implementations, control server 220 may receive the event information prior to receiving the user device information. In some implementations, control server 220 may determine whether the event affects user devices 210 based on the type of event (e.g., a one-car accident, a severe flood, etc.), the locations of user devices 210 (e.g., on a highway, in a building, on a river, etc.), whether multiple events are involved and/or the proximity of the multiple events, the location of the event (e.g., urban, suburban, rural), etc.

For example, a bomb threat in a city may require evacuation of the entire city. In such an example, control server 220 may determine that all users with user devices 210 located within the city are affected by the bomb threat. In another example, a fire in a city may require evacuation of certain buildings in the city. In such an example, control server 220 may determine that all users with user devices 210 located within the certain buildings of the city are affected by the fire. In still another example, a hazardous material spill may require evacuation of an area within a certain distance from the spill (e.g., a certain mile radius). In such an example, control server 220 may determine that all users with user devices 210 located within the certain distance from the spill are affected by the spill.

In some implementations, the event information may include an identification of the event (e.g., a hurricane, an earthquake, a fire, a train accident, a car accident, etc.); a location affected by the event (e.g., an entire city, certain portions of the city, a building, etc.); current inaccessible routes caused by the event (e.g., roads, streets, highways, etc. that are inaccessible, a police perimeter, a road closing, etc.); public advisory information (e.g., weather alerts, travel advisories, Amber alerts, civil defense alerts, tornado warnings, etc.); an approximate location of the event (e.g., latitude, longitude, a street address, a grid location on a map, etc.), an approximate point in time that the event occurred or was reported; and/or other information (e.g., information obtained from private or public websites, such as from video cameras, news wires, streaming media, “911” calls, geographic information systems, etc.).

As further shown in FIG. 6, process 600 may include determining custom event instructions for each user device based on the received information (block 630). For example, control server 220 may determine custom event instructions for each user device 210 based on the event application setup information, the user device information, and/or the event information. In some implementations, each of the custom event instructions may include recommended route instructions (e.g., driving directions, walking directions, flying directions, etc.) for physically moving away from an area affected by an event; information identifying an amount of time that may be required to travel each portion of the route (e.g., drive on Route 50 for an estimated time of five minutes); information identifying a distance associated with each portion of the route (e.g., drive on I-80 for ten miles); information associated with the event (e.g., a type of event, a location of the event, a severity of the event, etc.); images and/or maps associated with the route; a user interface (UI) and/or user experience (UX) that includes voice, text, audio, and/or video alerts that are event dependent; etc. In some implementations, control server 220 may utilize historical information associated with user devices 210, the area affected by the event, etc. to determine a most effective route away from the area as the recommended route.

In some implementations, each of the custom event instructions may include multiple recommended routes from which the user of user device 210 may select. In some implementations, if the user of user device 210 selects a particular recommended route, from the multiple recommended routes, but fails to follow the recommended route instructions, user device 210 may automatically select another one of the multiple recommended routes that may enable the user to leave the area of the event more quickly. In some implementations, custom event instructions provided to multiple user devices 210 at a same location may include different recommended route instructions. For example, the recommended route instructions may include different routes in order to prevent the multiple users of the multiple user devices 210 from taking the same route and causing traffic jams, may include staggered start times to prevent traffic jams, and/or may be different based on preferences setup by the multiple users via the event application.

In some implementations, control server 220 may determine the custom event instructions for user devices 210 in such a manner that a maximum number of users exit the area affected by the event in a minimum amount of time. In some implementations, control server 220 may utilize particular techniques to determine the custom event instructions for user devices 210. For example, control server 220 may utilize convex optimization techniques to solve a distributed control problem, such as having a large number of users exit the area affected by the event. Convex optimization may include a special class of mathematical optimization problems, and may include least-squares and linear programming problems. A convex optimization problem may include the following form:

minimize f₀(x)

subject to fᵢ(x)≦bᵢ, i=1, . . . ,m,

where the functions f₀, . . . , fₘ:Rⁿ→R are convex, e.g., satisfy:

fᵢ(αx+βy)≦αfᵢ(x)+βfᵢ(y)

for all x,yεRⁿ and all α,βεR with α+β=1, α≧0, and β≧0. A least-squares problem and a linear programming problem may both be special cases of the general convex optimization problem. Convex optimization techniques may minimize convex functions over convex sets. In some implementations, control server 220 may create a convex optimization problem based on the event application setup information, the user device information, and/or the event information. Control server 220 may solve the convex optimization problem to generate results. The results may include information utilized to generate the custom event instructions.

In some implementations, each of the custom event instructions may include information utilized to perform the calculations (e.g., convex optimization calculations) that generate each of the custom event instructions. For example, each of the custom event instructions may include the convex optimization problem that is solved by control server 220 (e.g., to generate each of the custom event instructions), functions of the convex optimization problem, and/or parameters (e.g., constraints) utilized by the convex optimization problem.

As further shown in FIG. 6, process 600 may include providing the custom event instructions to the user devices, where the user devices utilize an event application to follow or alter the custom event instructions (block 640). For example, control server 220 may provide the custom event instructions to corresponding user devices 210. In some implementations, control server 220 may provide the custom event instructions to user devices 210 in an encrypted format (e.g., based on encryption mechanisms). In some implementations, control server 220 may share encryption mechanisms (e.g., encryption keys) with user devices 210 so that user devices 210 may receive and decrypt the custom event instructions.

In some implementations, user devices 210 may display the custom event instructions to the users of user devices 210. In some implementations, one or more user devices 210 may alter the custom event instructions (e.g., based on the information utilized to perform the calculations that generated the custom event instructions) prior to displaying the custom event instructions to the users of the one or more user devices 210. For example, if a particular user device 210 changes locations (e.g., when the user is driving in a vehicle with the particular user device 210) just prior to receiving the custom event instructions, the particular user device 210 may alter the custom event instructions based on a new location of the particular user device 210. In such an example, the user may be unable to utilize a route proposed by the custom event instructions based on the new location, and the particular user device 210 may alter the proposed route accordingly.

In some implementations, one or more users of user devices 210 may follow the custom event instructions until the users exit the area of the event. For example, a particular user may follow the custom event instructions provided by a particular user device 210 until the particular user completes the instructions provided by the custom event instructions (e.g., follows a route proposed by the custom event instructions and is located at a safe location away from the area of the event). In some implementations, one or more users of user devices 210 may not follow the custom event instructions. In such implementations, the one or more user devices 210 associated with the one or more users may alter the custom event instructions based on the one or more users' failure to follow the custom event instructions (e.g., the users' actions). For example, a particular user of a particular user device 210 may be instructed to leave immediately and take a particular route (e.g., Route 45). However, assume that the particular user is delayed and cannot leave immediately (e.g., the particular user needs to pack up supplies, pick up children, etc.), and that the particular route has become inaccessible. In such an example, the particular user device 210 may alter custom event instructions to propose a new route to the particular user, and/or control server 220 may send new custom event instructions to the particular user device 210 that proposes a new route to the particular user.

As further shown in FIG. 6, process 600 may include periodically updating the custom event instructions, if necessary, based on the user device information and the event information (block 650). For example, control server 220 may periodically update one or more of the custom event instructions, if necessary, based on changes to the user device information received from user devices 210 and/or changes to the event information. In some implementations, a number of users associated with user devices 210 may not follow the custom event instructions, and such information may be provided to control server 220 via the user device information. For example, if multiple users decide not follow the custom event instructions and to take the same route (e.g., the same highway), a traffic jam may occur on the highway. In such an example, control server 220 may update the custom event instructions for the multiple users and/or other users to instruct them to utilize a different route if possible.

In some implementations, circumstances associated with the event may change, and such information may be provided to control server 220 via the event information. For example, if a wildfire changes directions (e.g., due to wind conditions) and causes a particular road to become dangerous and inaccessible, control server 220 may update the custom event instructions for users, utilizing the particular road, to instruct them to utilize a different route if possible.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

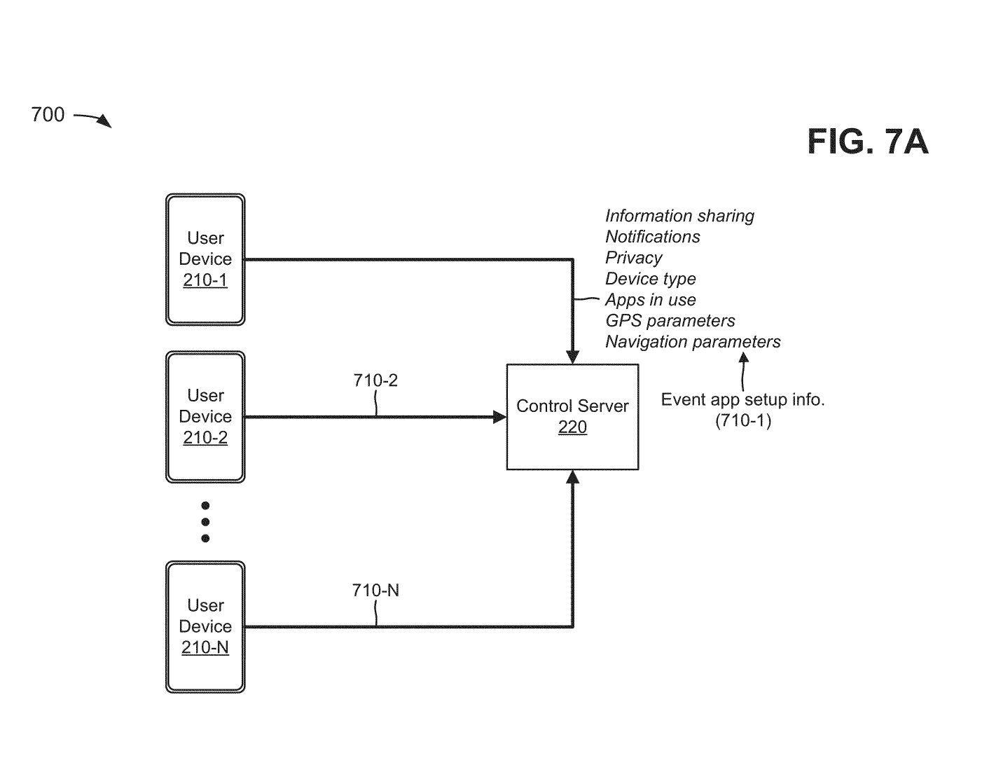

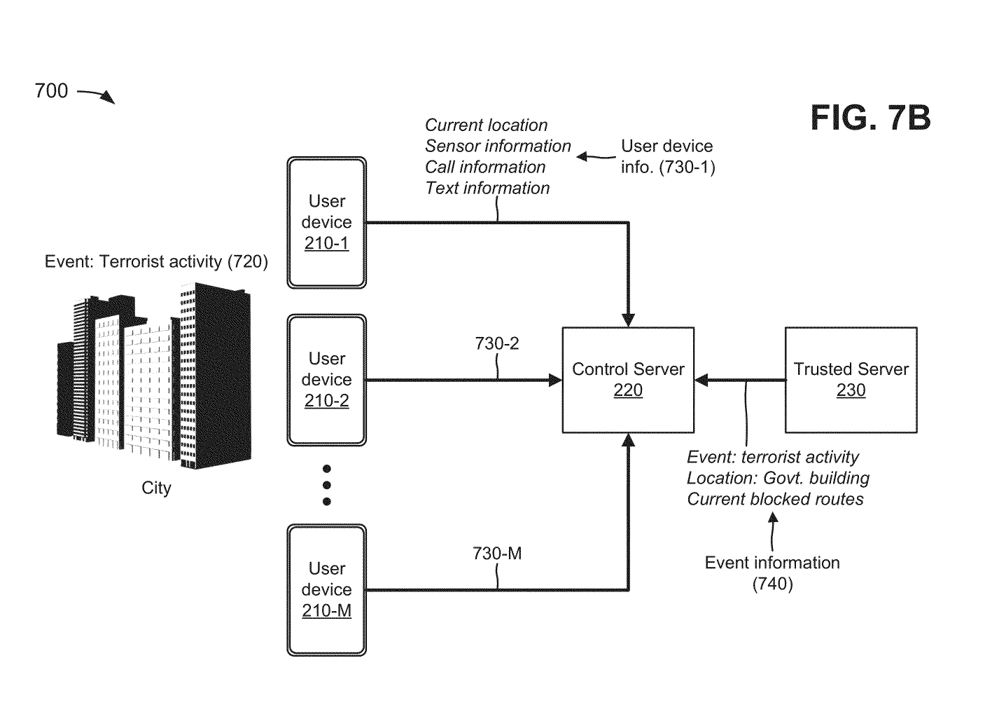

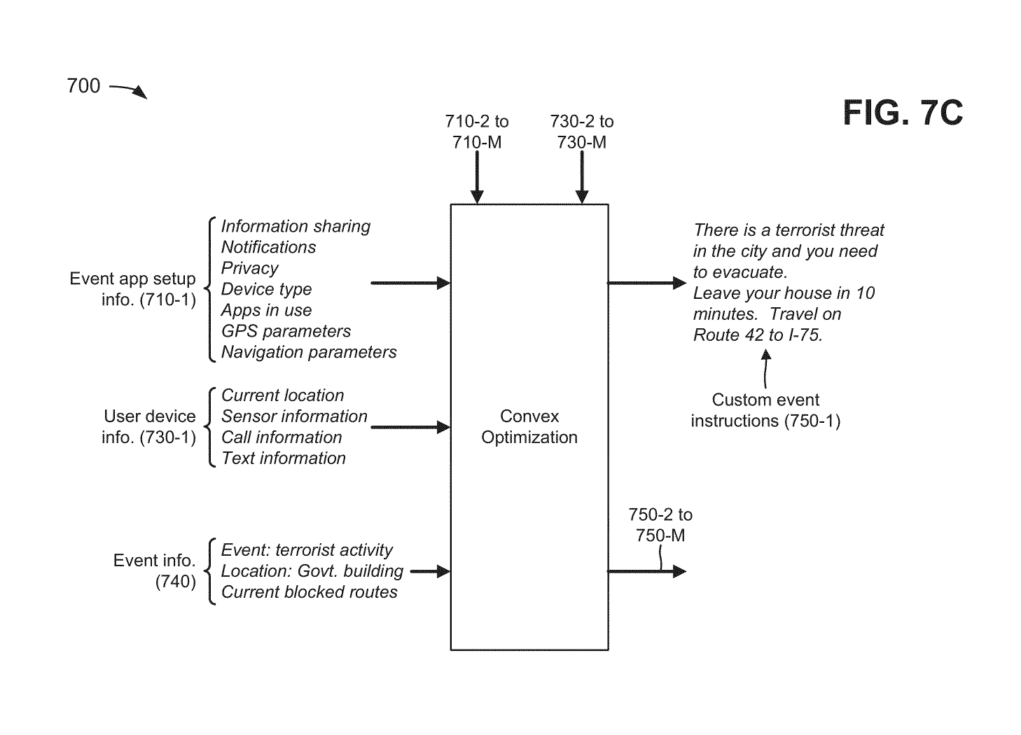

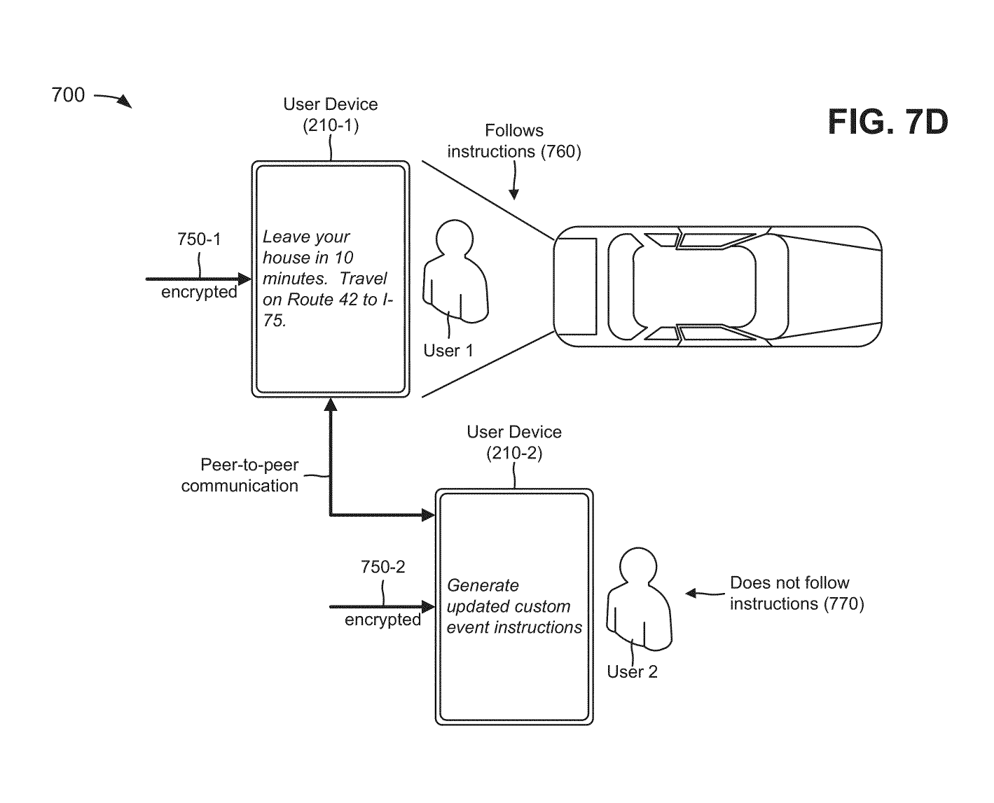

FIGS. 7A-7D are diagrams of an example 700 relating to example process 600 shown in FIG. 6. With reference to FIG. 7A, assume that multiple user devices 210-1 through 210-N (collectively referred to herein as user devices 210) have downloaded the event application. Further, assume that the event application has been installed on user devices 210, and that installation of the event application causes user devices 210 to provide event application setup information 710 to control server 220. For example, user device 210-1 may provide event application setup information 710-1 to control server 220, user device 210-2 may provide event application setup information 710-2 to control server 220, etc. As further shown in FIG. 7A, event application setup information 710-1 may include preferences defined by a user of user device 210-1, such as preferences associated with information sharing (e.g., sharing GPS coordinates, navigation control, etc. with the event application); notifications (e.g., to whom to send notifications); privacy (e.g., sharing event actions with other users); a device type (e.g., model, capabilities, etc.); applications in use (e.g., GPS, a video application, etc.); GPS parameters; navigation parameters; etc. associated with user device 210-1. User devices 210-2 through 210-N may provide, to control server 220, similar event application setup information 710 as provided by user device 210-1. Control server 220 may receive event application setup information 710, and may store event application setup information 710 (e.g., in memory 330, FIG. 3).

Now assume that an event 720 (e.g., terrorist activity) occurs in a city, and that event 720 requires evacuation of the city, as shown in FIG. 7B. Further, assume that event 720 affects particular user devices 210 (e.g., user devices 210-1 through 210-M, where M<N), and requires users of the particular user devices 210 to exit the city. In some implementations, the event application may be constantly executing on the particular user devices 210, and control server 220 may inform the particular user devices 210 of event 720 via the event application. In some implementations, the event application may executing in the background (e.g., in a dormant state) of the particular user devices 210, and control server 220 informs the particular user devices 210 of event 720 the event application may begin executing in an active state. In some implementations, the event application may not be executing on the particular user devices 210, and the users of the particular user devices 210 may hear about event 720 and initiate the event application on the particular user devices 210.

When event 720 occurs, the particular user devices 210 may provide user device information 730 to control server 220, as further shown in FIG. 7B, based on the configuration of the event application on the particular user devices 210 (as discussed above). For example, user device 210-1 may provide user device information 730-1 to control server 220, user device 210-2 may provide user device information 730-2 to control server 220, etc. As further shown, user device information 730-1 may include a current location (e.g., GPS coordinates, cellular triangulation location, etc.); sensor information (e.g., sound from a microphone, video from a camera, vibration, etc.); call information; text message information; etc. associated with user device 210-1. User devices 210-2 through 210-M may provide, to control server 220, similar user device information 730 as provided by user device 210-1. Control server 220 may receive user device information 730, and may store user device information 730 (e.g., in memory 330, FIG. 3).

As further shown in FIG. 7B, when event 720 occurs, trusted server 230 may provide event information 740 to control server 220. Event information 740 may include an identification of event 720 (e.g., terrorist activity), a location of event 720 (e.g., a government building), current blocked routes caused by event 720, etc. Control server 220 may receive event information 740, and may store event information 740 (e.g., in memory 330, FIG. 3).

With reference to FIG. 7C, control server 220 may utilize event application setup information 710, user device information 730, and/or event information 740 to determine custom event instructions 750 for the particular user devices 210. For example, as shown in FIG. 7C, control server 220 may utilize event application setup information 710-1, user device information 730-1, and/or event information 740 to set up a convex optimization problem that determines custom event instructions 750-1 for user device 210-1. Custom event instructions 750-1 may include information associated with event 720 (e.g., “There is a terrorist threat in the city and you need to evacuate”), a proposed route to utilize (e.g., “Leave your house in 10 minutes. Travel on Route 42 to I-75.”), maps, images, etc. Control server 220 may determine similar custom event instructions 750, as custom event instructions 750-1, for user devices 210-2 through 210-M.

As shown in FIG. 7D, control server 220 may provide custom event instructions 750-1 to user device 210-1 in an encrypted format. User device 210-1 may decrypt custom event instructions 750-1, and may display custom event instructions 750-1 to a first user. For example, user device 210-1 may display “Leave your house in 10 minutes. Travel on Route 42 to I-75.” to the first user. The first user may follow custom event instructions 750-1, as indicated by reference number 760 in FIG. 7D, and may utilize a vehicle to travel on Route 42 to I-75.

As further shown in FIG. 7D, control server 220 may provide custom event instructions 750-2 to user device 210-2 in an encrypted format. User device 210-2 may decrypt custom event instructions 750-2, and may display custom event instructions 750-2 to a second user. However, the second user may not follow custom event instructions 750-2, as indicated by reference number 770 in FIG. 7D. Based on the second user not following custom event instructions 750-2, user device 210-2 may generate updated custom event instructions 750-2 (e.g., proposing a new route to the second user). As further shown, user device 210-1 and user device 210-2 may exchange information (e.g., event actions of the first user and/or the second user, current locations, etc.) via peer-to-peer communications.

As indicated above, FIGS. 7A-7D are provided merely as an example. Other examples are possible and may differ from what was described with regard to FIGS. 7A-7D. In some implementations, the various operations described in connection with FIGS. 7A-7D may be performed automatically or at the request of the user.

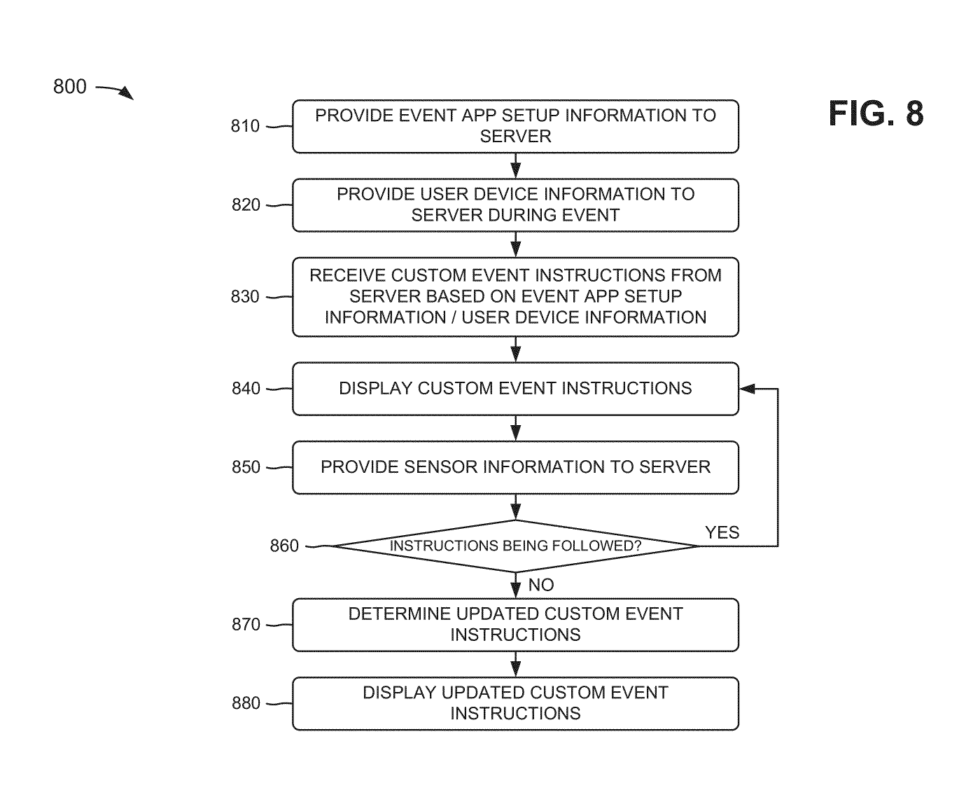

FIG. 8 is a flow chart of an example process 800 for displaying and updating custom event instructions received during an occurrence of an event. In some implementations, one or more process blocks of FIG. 8 may be performed by user device 210 (e.g., via the event application). In some implementations, one or more process blocks of FIG. 8 may be performed by another device or a group of devices separate from or including user device 210.

As shown in FIG. 8, process 800 may include providing event application setup information to a server (block 810). For example, a user of user device 210 may provide preferences, during configuration of the event application by the user, to control server 220, as described above in connection with FIGS. 4-5B. In some implementations, the preferences may be referred to as event application setup information, and may include, for example, providing the event application with access to GPS coordinates, a navigation application, data usage, etc. of user device 210; user-specified routes to take during an event; types and methods of providing notifications to send during an event; sharing location information and user actions during the event with other user devices 210; a type of user device 210; etc.

As further shown in FIG. 8, process 800 may include providing user device information to the server during an event (block 820). For example, user device 210 may provide user device information, associated with user device 210, to control server 220 when user device 210 is physically located in an area affected by an event and based on the configuration of the event application on user device 210 (as discussed above). The user device information may include, for example, a current location, call information, text message information, data usage information, etc. associated with user device 210 at the time of the event. For example, if user device 210 is located in a building where a hostage situation is occurring, user device 210 may provide current GPS coordinates of user device 210 to control server 220 so that control server 220 may determine whether the user is in danger.

As further shown in FIG. 8, process 800 may include receiving custom event instructions from the server based on the event application setup information and/or the user device information (block 830). For example, user device 210 may receive custom event instructions from control server 220 based on the event application setup information and/or the user device information provided by user device 210. In some implementations, the custom event instructions may be determined based solely on the event application setup information (e.g., based on the preferred routes provided by the user to the event application). In some implementations, the custom event instructions may be determined based solely on the user device information (e.g., based on the current location of user device 210 and the proximity of the current location to the event). In some implementations, the custom event instructions may be determined based on a combination of the event application setup information, the user device information, and/or the event information. For example, the event application setup information may include information identifying a preferred route of the user that is inaccessible. In such an example, the custom event instructions may not include information identifying the preferred route.

In some implementations, the custom event instructions may be provided in an encrypted format, and user device 210 may decrypt the custom event instructions. In some implementations, the custom event instructions may include recommended route instructions (e.g., driving directions, walking directions, flying directions, etc.) for physically moving away from an area affected by an event, information identifying an amount of time that may be required to travel each portion of the route (e.g., drive on I-95 for an estimated time of twenty minutes); information identifying a distance associated with each portion of the route (e.g., drive on Route 1 for fifteen miles); information associated with the event (e.g., a type of event, a location of the event, a severity of the event, etc.); images and/or maps associated with the route; etc.

As further shown in FIG. 8, process 800 may include displaying the custom event instructions (block 840). For example, user device 210 may display the custom event instructions to the user of user device 210. In some implementations, user device 210 may display the custom event instructions via a navigation application associated with user device 210. For example, when the custom event instructions are received, the event application may cause user device 210 to execute the navigation application. The navigation application may obtain the recommended route information from the custom event instructions, and may obtain a current location of user device 210. The navigation application may display a map showing the current location of user device 210, and may display turn-by-turn directions in the map as user device 210 travels along the recommended route. In some implementations, the navigation application may audibly provide the turn-by-turn directions to the user.

As further shown in FIG. 8, process 800 may include providing sensor information to the server (block 850). For example, user device 210 may provide sensor information (e.g., associated with sensors of user device 210) to control server 220. In some implementations, user device 210 may enable a microphone of user device 210 (e.g., to provide sounds encountered by user device 210 to control server 220); a camera of user device 210 (e.g., to provide video captured by user device 210 to control server 220); a motion sensor of user device 210 (e.g., to provide vibrations encountered by user device 210 to control server 220); etc. Such sensor information may enable control server 220 to assess current conditions associated with the area of the event.

As further shown in FIG. 8, process 800 may include determining whether the custom event instructions are being followed (block 860). For example, user device 210 may determine whether the user of user device 210 is following the custom event instructions. In some implementations, user device 210 may determine whether the user is following the custom event instructions based on actions performed by the user. For example, assume that the custom event instructions instruct the user to leave a current location after a particular amount of time (e.g., ten minutes). Further, assume that the user takes longer than ten minutes to leave, and that user device 210 determines this based on user device 210 remaining at the current location for longer than ten minutes. In such an example, user device 210 may determine that the custom event instructions are not being followed by the user. In another example, assume that the custom event instructions instruct the user to utilize a certain road for five miles, and that the user travels on the road for one mile and is stuck in traffic. In such an example, user device 210 may determine that the custom event instructions are not being followed by the user because the traffic is preventing the user from traveling the certain road for five miles.

In still another example, assume that the custom event instructions instruct the user to travel a particular route for a particular amount of time, and that the user travels the particular route for the particular amount of time. In such an example, user device 210 may determine that the custom event instructions are being followed by the user. Now assume that the user travels the particular route, but that it takes the user a longer period of time than the particular amount of time. In such a scenario, user device 210 may still determine that the custom event instructions are being followed by the user if the period of time does not exceed the particular amount of time by a particular threshold.

As further shown in FIG. 8, if the custom event instructions are being followed (block 860—YES), process 800 may return to process block 840. For example, if user device 210 determines that the user is following the custom event instructions, user device 210 may continue to display the custom event instructions to the user. In some implementations, user device 210 may determine that the user is following the custom event instructions based on actions performed by the user. For example, if the custom event instructions instruct the user to utilize particular streets and the user utilizes the particular streets, user device 210 may determine that the user is following the custom event instructions. In such an example, user device 210 may continue to display the turn-by-turn directions that are generated based on the custom event instructions.

As further shown in FIG. 8, if the custom event instructions are not being followed (block 860—NO), process 800 may include determining updated custom event instructions (block 870). For example, if user device 210 determines that the user is not following the custom event instructions, user device 210 may determine updated custom event instructions. In some implementations, user device 210 may determine that the user is not following the custom event instructions based on actions performed by the user. For example, if the custom event instructions instruct the user to utilize a particular highway and the user does not utilize the particular highway, user device 210 may determine that the user is not following the custom event instructions. In such an example, user device 210 may determine updated custom event instructions for the user.

In some implementations, the custom event instructions may include the information associated with the calculations performed by control server 220 to determine the custom event instructions for user device 210 and/or for other user devices 210. In some implementations, user device 210 may utilize the information associated with the calculations to determine the updated custom event instructions. For example, user device 210 may determine the updated custom event instructions in such a manner that that the user exits the area affected by the event in a minimum amount of time. In some implementations, user device 210 may utilize particular techniques to determine the updated custom event instructions. For example, user device 210 may utilize convex optimization techniques to determine the updated custom event instructions. The convex optimization techniques may take into consideration the other custom event instructions provided to other user devices 210 when determining the updated custom event instructions.

In some implementations, even if the user is not following the custom event instructions, user device 210 and/or control server 220 may determine that the custom event instructions are still valid and may not determine updated custom event instructions. In such implementations, user device 210 may continue to display the custom event instructions to the user.

In some implementations, user device 210 may periodically monitor the custom event instructions, even though the user is following the custom event instructions, to determine whether changed conditions may require user device 210 and/or control server 220 to determine updated custom event instructions. For example, assume that the user is following the custom event instructions and is utilizing a particular highway. Further, assume that a portion of the particular highway has subsequently collapsed due to an earthquake. In such an example, user device 210 receive updated information from control server 220 (e.g., indicating the highway collapse), and may determine updated custom event instructions. Alternatively, or additionally, control server 220 may provide updated custom event instructions to user device 210 based on the highway collapse.

As further shown in FIG. 8, process 800 may include displaying the updated custom event instructions (block 880). For example, user device 210 may display the updated custom event instructions to the user of user device 210. In some implementations, user device 210 may display the updated custom event instructions via the navigation application associated with user device 210. For example, when the updated custom event instructions are determined, the event application may cause user device 210 to execute the navigation application. The navigation application may obtain the recommended route information from the updated custom event instructions, and may obtain a current location of user device 210. The navigation application may display a map showing the current location of user device 210, and may display turn-by-turn directions in the map as user device 210 travels along the recommended route. In some implementations, the navigation application may audibly provide the turn-by-turn directions to the user.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

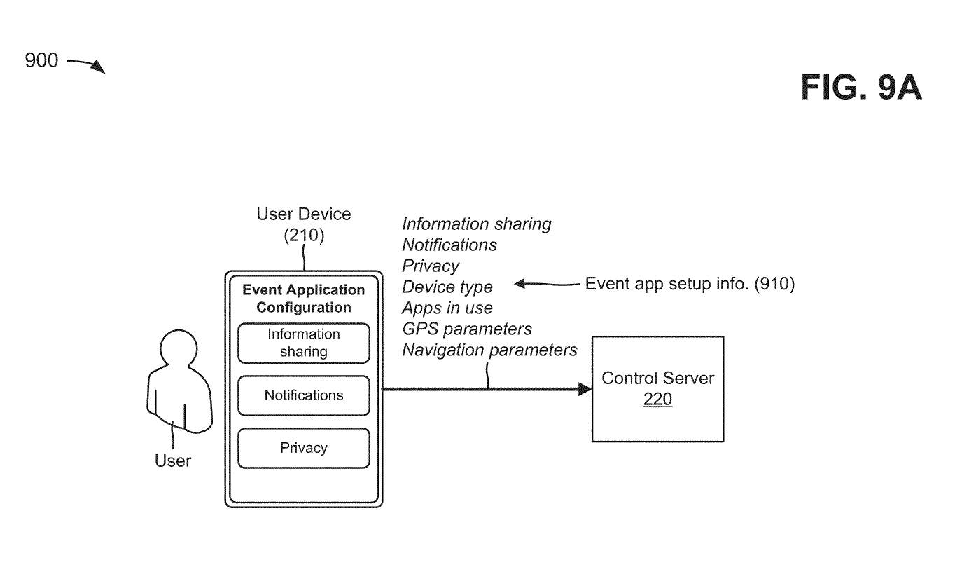

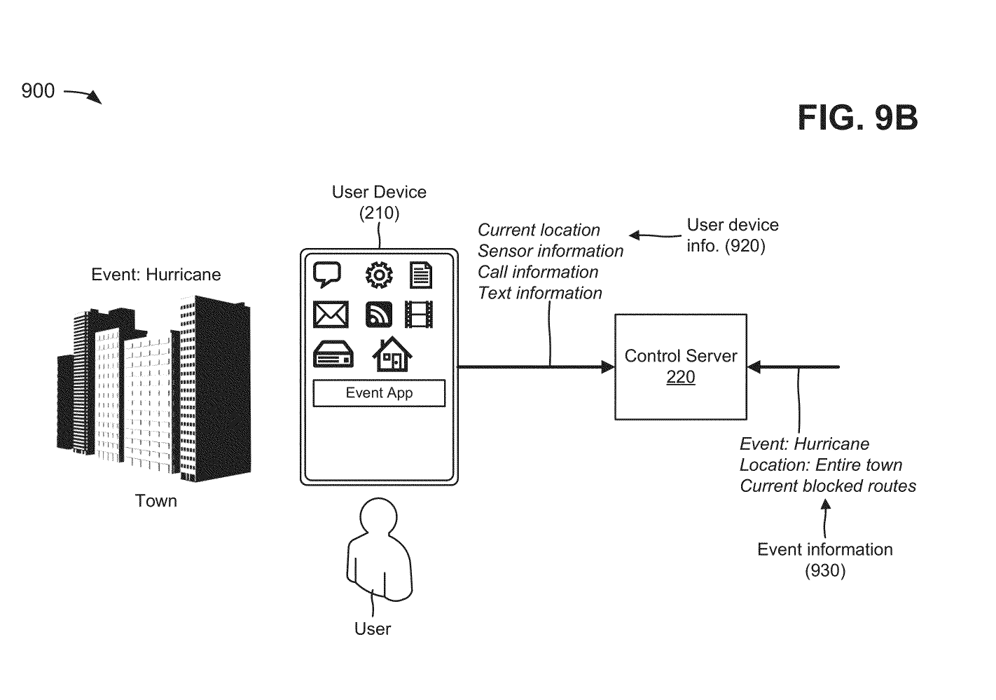

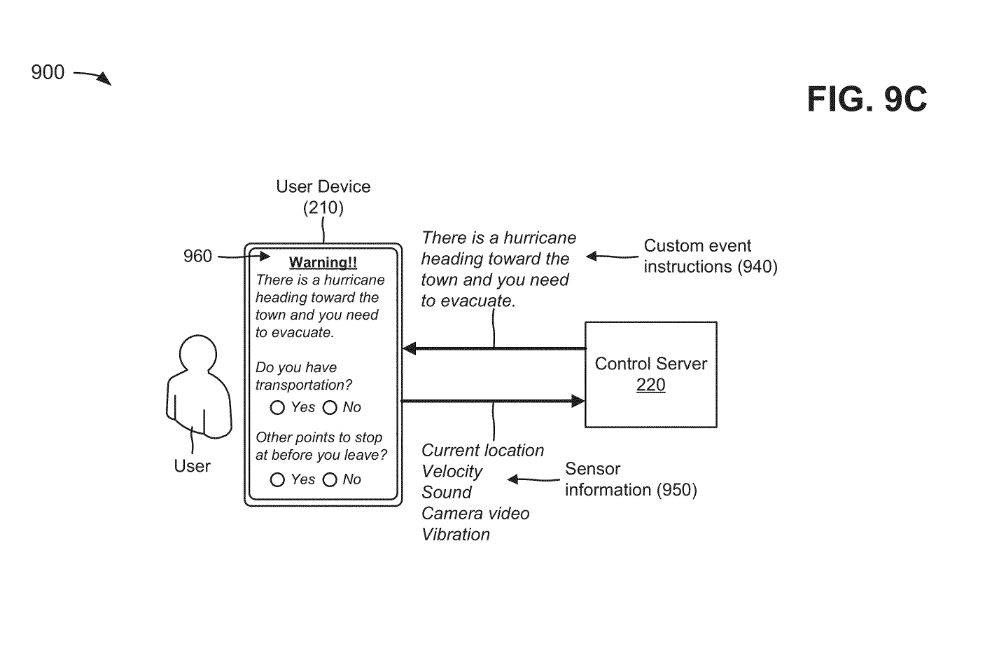

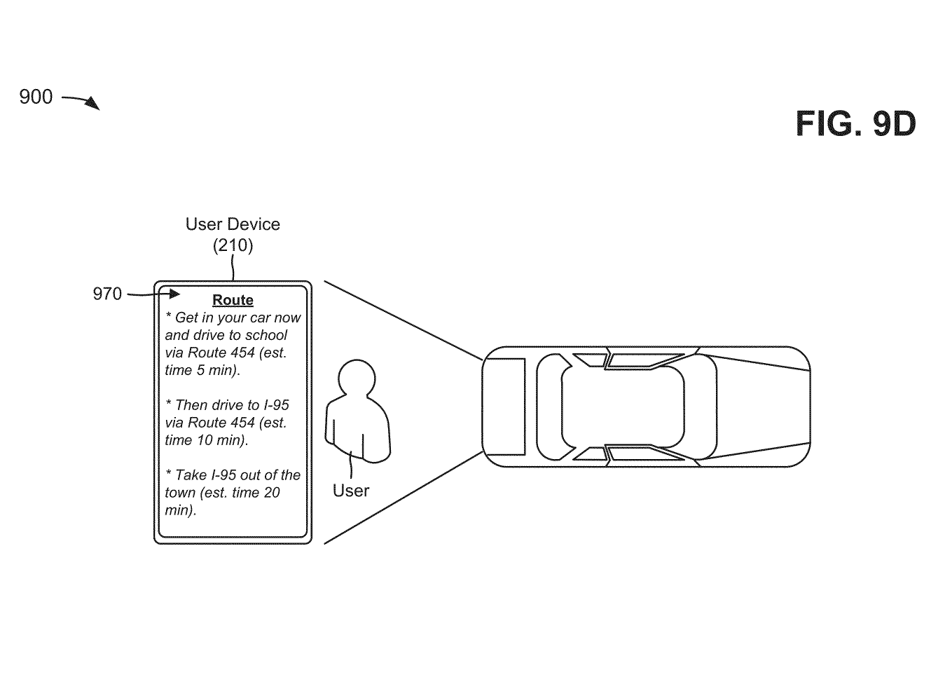

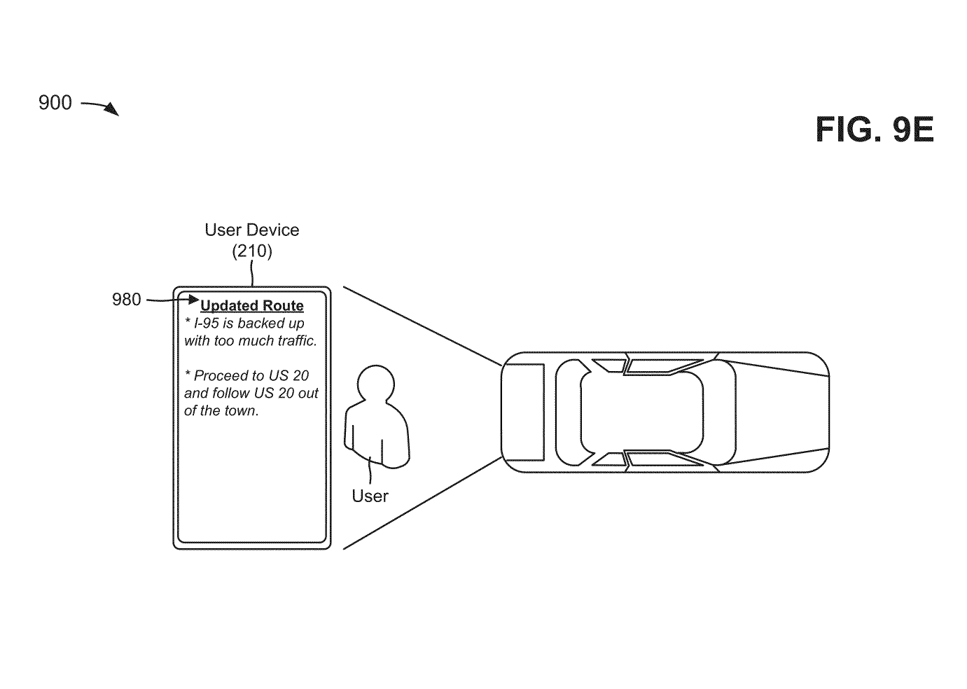

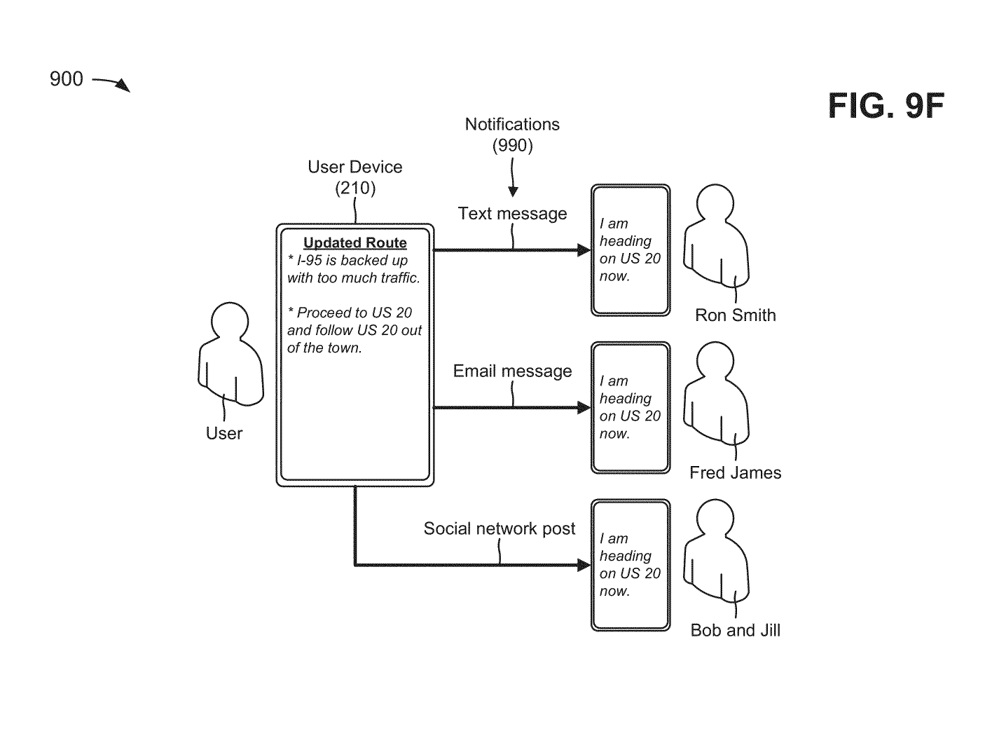

FIGS. 9A-9F are diagrams of an example 900 relating to example process 800 shown in FIG. 8. With reference to FIG. 9A, assume that a user is associated with user device 210, and that the user has caused user device 210 to download the event application from control server 220. Further, assume that the user causes user device 210 to install the event application, and that installation of the event application causes user device 210 to provide event application setup information 910 to control server 220. As further shown in FIG. 9A, event application setup information 910 may include preferences defined by the user, such as preferences associated with information sharing, notifications, privacy settings, a device type, applications in use, GPS parameters, navigation parameters, etc. associated with user device 210. Control server 220 may receive event application setup information 910, and may store event application setup information 910 (e.g., in memory 330, FIG. 3).

Now assume that an event (e.g., a hurricane) occurs in a town, and that the event requires evacuation of the town, as shown in FIG. 9B. Further, assume that the event affects the user of user device 210, and requires the user to exit the town. When the event occurs, user device 210 may provide user device information 920 to control server 220, as further shown in FIG. 9B, based on the configuration of the event application on user device 210 (as discussed above). As further shown, user device information 920 may include a current location, sensor information, call information, text message information; etc. associated with user device 210. Control server 220 may receive user device information 920, and may store user device information 920 (e.g., in memory 330, FIG. 3). As further shown in FIG. 9B, when the event occurs, control server 220 may receive event information 930 (e.g., from trusted server 230, not shown). Event information 930 may include an identification of the event (e.g., a hurricane), a location of the event (e.g., the entire town), current blocked routes caused by the event, etc. Control server 220 may store event information 930 (e.g., in memory 330, FIG. 3).

With reference to FIG. 9C, control server 220 may utilize event application setup information 910, user device information 920, and/or event information 930 to determine custom event instructions 940 for user device 210. For example, as shown in FIG. 9C, control server 220 may utilize event application setup information 910, user device information 920, and/or event information 930 to determine custom event instructions 940 that include information associated with the event (e.g., “There is a hurricane heading toward the town and you need to evacuate”), a proposed route to utilize, maps, images, etc.

As further shown in FIG. 9C, when user device 210 receives custom event instructions 940, the event application may cause user device 210 to provide sensor information 950 to control server 220. Sensor information 950 may include, for example, a current location of user device 210 (e.g., provided by a GPS component of user device 210); a velocity of user device 210 (e.g., provided by GPS coordinates of user device 210); sound received by user device 210 (e.g., provided by a microphone of user device 210); video captured by user device 210 (e.g., provided by a camera of user device 210); vibrations encountered by user device 210 (e.g., provided by a motion sensor of user device 210); etc.

As further shown in FIG. 9C, when user device 210 receives custom event instructions 940, the event application may cause user device 210 to display a user interface 960. User interface 960 may include information provided by custom event instructions 940 (e.g., “There is a hurricane heading toward the town and you need to evacuate”). User interface 960 may request that the user indicate whether the user has access to transportation. For example, assume that the user does not own a vehicle but is able to be a passenger in a friend's vehicle. In such an example, the user may indicate that the user has access to transportation. User interface 960 may request that the user indicate whether the user has other points to stop at before leaving the town. In some implementations, user interface 960 may require the user to input other information (e.g., a time when the user is able to leave, whether the user is injured or trapped, etc.)

User device 210 may utilize custom event instructions 940 and/or information received via user interface 960 to determine a recommended route for the user to exit the town. In some implementations, the recommended route may be provided by custom event instructions 940. In some implementations, the recommended route provided by custom event instructions 940 may be altered by user device 210 based on the information received via user interface 960. In some implementations, assume that the event application causes user device 210 to execute a navigation application of user device 210. The navigation application may obtain the recommended route information, and may obtain a current location of user device 210. The navigation application may display a map showing the current location of user device 210, and may display turn-by-turn directions in the map as user device 210 travels along the recommended route. For example, as shown in FIG. 9D, the navigation application may cause user device 210 to display a user interface 970. User interface 970 may include textual and/or audible information describing the recommended route for the user out of the town (e.g., “Get in your car now and drive to school via Route 454 (est. time 5 min). Then drive to I-95 via Route 454 (est. time 10 min). Take I-95 out of the town (est. time 20 min).”).

As the user is traveling the recommended route, assume that user device 210 receives information (e.g., from control server 220) indicating that the recommended route may not be the best route (e.g., information indicating that I-95 is backed up with traffic). Based on this information, user device 210 may determine an updated route for the user, and may display the updated route in a user interface 980, as shown in FIG. 9E. User interface 980 may include textual and/or audible information describing the updated route for the user out of the town (e.g., “I-95 is backed up with too much traffic. Proceed to US 20 and follow US 20 out of the town.”).

When the user begins traveling the recommended route or the updated route, the event application may cause user device 210 to generate notifications 990, as shown in FIG. 9F. For example, based on event application setup information 910 (FIG. 9A), the event application may cause user device 210 to provide a text message (e.g., indicating that “I am heading on US 20 now”) to a device associated with Ron Smith; an email message (e.g., indicating that “I am heading on US 20 now”) to a device associated with Fred James; and a social network post (e.g., indicating that “I am heading on US 20 now”) to a device associated with Bob and Jill.

As indicated above, FIGS. 9A-9F are provided merely as an example. Other examples are possible and may differ from what was described with regard to FIGS. 9A-9F. In some implementations, the various operations described in connection with FIGS. 9A-9F may be performed automatically or at the request of the user.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The foregoing disclosure provides illustration and description, but is not intended to be exhaustive or to limit the implementations to the precise form disclosed. Modifications and variations are possible in light of the above disclosure or may be acquired from practice of the implementations.

A component is intended to be broadly construed as hardware, firmware, or a combination of hardware and software.

User interfaces may include graphical user interfaces (GUIs) and/or non-graphical user interfaces, such as text-based interfaces. The user interfaces may provide information to users via customized interfaces (e.g., proprietary interfaces) and/or other types of interfaces (e.g., browser-based interfaces, etc.). The user interfaces may receive user inputs via one or more input devices, may be user-configurable (e.g., a user may change the sizes of the user interfaces, information displayed in the user interfaces, color schemes used by the user interfaces, positions of text, images, icons, windows, etc., in the user interfaces, etc.), and/or may not be user-configurable. Information associated with the user interfaces may be selected and/or manipulated by a user (e.g., via a touch screen display, a mouse, a keyboard, a keypad, voice commands, etc.).

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has.” “have,” “having,” or the like are intended to be open-ended terms. Further, the phrase “based on” is intended to mean “based, at least in part, on” unless explicitly stated otherwise.

What is claimed is:

1. A method, comprising:
receiving, by a device, event application setup information associated with a plurality of user devices,
the event application setup information including information provided by the plurality of user devices during configuration of an event application;
receiving, by the device, user device information associated with the plurality of user devices,
the user device information including information identifying current locations of the plurality of user devices;
receiving, by the device, event information associated with an event that affects the plurality of user devices,
the event information including:
information identifying the event, and
information identifying a location of the event;
determining, by the device, custom event instructions for each of the plurality of user devices based on the event application setup information, the user device information, and the event information,
each of the custom event instructions including information describing a recommended route, away from the location of the event, that is customized for a corresponding one of the plurality of user devices; and
providing, by the device, each of the custom event instructions to the corresponding one of the plurality of user devices.

2. The method of claim 1, where the event information further includes:
information identifying a type of the event, and
information identifying routes that are inaccessible due to the event.

3. The method of claim 1, further comprising:
receiving updated user device information or updated event information; and
updating one or more of the custom event instructions based on the update user device information or the update event information

4. The method of claim 1, where the event application setup information for a particular user device, of the plurality of user devices, includes at least one of:
information indicating whether the event application has access to global positioning system (GPS) coordinates of the particular user device or to a navigation application of the particular user device,
information indicating user-specified routes to utilize during a particular event,
information indicating notifications to transmit during the particular event, and
information indicating whether to share location information of the particular user device, during the particular event, with other user devices of the plurality of user devices.

5. The method of claim 1, where determining the custom event instructions comprises:
creating a convex optimization problem based on the event application setup information, the user device information, and the event information; and
solving the convex optimization problem to generate the custom event instructions for each of the plurality of user devices.

6. A device, comprising:
one or more processors to:
receive event application setup information associated with a plurality of user devices,
the event application setup information including information provided by the plurality of user devices during configuration of an event application; receive user device information associated with the plurality of user devices,
the user device information including information identifying current locations of the plurality of user devices;
receive event information associated with an event,
the event information including:
information identifying the event, and
information identifying a location of the event;
determine that the event affects the plurality of user devices based on the location of the event and the current locations of the plurality of user devices;
determine custom event instructions for each of the plurality of user devices based on the event application setup information, the user device information, and the event information,
each of the custom event instructions including information describing a recommended route, away from the location of the event, that is customized for a corresponding one of the plurality of user devices; and
provide each of the custom event instructions to the corresponding one of the plurality of user devices.

7. The device of claim 6, where the event information further includes:
information identifying a type of the event, and
information identifying routes that are inaccessible due to the event.

8. The device of claim 6, where the one or more processors are further to:
receive updated user device information or updated event information; and
update one or more of the custom event instructions based on the update user device information or the update event information

9. The device of claim 6, where the event application setup information for a particular user device, of the plurality of user devices, includes at least one of:
information indicating whether the event application has access to global positioning system (GPS) coordinates of the particular user device or to a navigation application of the particular user device,
information indicating user-specified routes to utilize during a particular event,
information indicating notifications to transmit during the particular event, and
information indicating whether to share location information of the particular user device, during the particular event, with other user devices of the plurality of user devices.

10. The device of claim 6, where, when determining the custom event instructions, the one or more processors are further to:
create a convex optimization problem based on the event application setup information, the user device information, and the event information; and
solve the convex optimization problem to generate the custom event instructions for each of the plurality of user devices.

11. A method, comprising:
providing, by a user device and to a server device, event application setup information associated with the user device,
the event application setup information including information provided by a user of the user device during configuration of an event application;
providing, by the user device and to the server device, user device information associated with the user device,
the user device information including information identifying a current location of the user device, and
the user device information being provided to the server device during an event that affects the user device;
receiving, by the user device and from the server device, custom event instructions based on the event application setup information, the user device information, and the event,
the custom event instructions including information describing a recommended route, away from a location of the event, that is customized for the user device; and
displaying, by the user device, the custom event instructions.

12. The method of claim 11, further comprising:
providing sensor information, associated with the user device, to the server device,
the sensor information including one or more of:
sound information received by a microphone of the user device,
video information received by a camera of the user device, or
vibration information received by a motion sensor of the user device.

13. The method of claim 11, further comprising:
determining whether the custom event instructions are being followed by the user of the user device; and
continuing to display the custom event instruction when the custom event instructions are being followed by the user of the user device.

14. The method of claim 13, further comprising:
determining updated custom event instructions when the custom event instructions are not being followed by the user of the user device; and
displaying the updated custom event instructions.

15. The method of claim 11, where, prior to providing the event application setup information to the server device, the method comprises:
providing, to the server device, information identifying preferences for the event application;
receiving, from the server device, configuration information for the event application based on the information identifying the preferences; and
configuring the event application based on the configuration information.

16. A user device, comprising:
one or more processors to:
provide, to a server device, event application setup information associated with the user device,
the event application setup information including information provided by a user of the user device during configuration of an event application;
provide, to the server device, user device information associated with the user device,
the user device information including information identifying a current location of the user device, and
the user device information being provided to the server device during an event that affects the user device;
receive, from the server device, custom event instructions based on the event application setup information, the user device information, and the event,
the custom event instructions including information describing a recommended route, away from a location of the event, that is customized for the user device; and
display the custom event instructions.

17. The user device of claim 16, where the one or more processors are further to:
provide sensor information, associated with the user device, to the server device,
the sensor information including one or more of:
sound information received by a microphone of the user device,
video information received by a camera of the user device, or
vibration information received by a motion sensor of the user device.

18. The user device of claim 16, where the one or more processors are further to:
determine whether the custom event instructions are being followed by the user of the user device; and
continue to display the custom event instruction when the custom event instructions are being followed by the user of the user device.

19. The user device of claim 18, where the one or more processors are further to:
determine updated custom event instructions when the custom event instructions are not being followed by the user of the user device,
the updated custom event instructions being determined via complex optimization techniques; and
display the updated custom event instructions.

20. The user device of claim 16, where, prior to providing the event application setup information to the server device, the one or more processors are further to:
provide, to the server device, information identifying preferences for the event application;
receive, from the server device, configuration information for the event application based on the information identifying the preferences; and
configure the event application based on the configuration information.
